(19) United States
(12) Patent Application Publication
(10) Pub. No.: US 2007/0095816 A1
(43) Pub. Date: May 3, 2007

(54) Portable heating device with portable power source

(76) Inventor: Tsung-Cheng Tsai, Jhudong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/356,058

(22) Filed: Feb. 17, 2006

(30) Foreign Application Priority Data
Oct. 27, 2005 (TW) 94137707

(51) Int. Cl. H05B 3/02

(52) U.S. Cl. 219/482

(57) ABSTRACT

A portable heating controller with a portable power source is provided, which has a portable power source, a capacity detection circuit, a discharging controller, and a processor. The portable power source is used to supply power to the portable heating controller, and the capacity detection circuit is coupled to the portable power source to detect the remaining capacity of the portable power source. The discharging controller is connected between the portable power source and the heating apparatus to connect or disconnect the discharging path therebetween. The processor is coupled to the capacity detection circuit to receive the detecting result and is coupled to the discharging controller to control a conductive frequency to adjust a power level of the portable heating controller.

### RELATED APPLICATIONS

The present application is based on, and claims priority from, Taiwan Application Serial Number 94137707, filed Oct. 27, 2005, the disclosure of which is hereby incorporated by reference herein in its entirety.

### BACKGROUND

1. Field of Invention

The present invention relates to a portable heating device powered by battery, fuel cell or solar cell such kind of portable power source, and especially relates to a portable heating device that can control heating power level and display the remaining capacity of the portable power source.

2. Description of Related Art

Heating devices, such as electric blankets and heaters, are used in everyday life to stay warm and comfortable. People working in a cold environment need heating devices that are convenient and efficient.

Although there are many heating devices available, they are either cumbersome or only work with non-portable power supplies. Even those heating devices having portable power supplies cannot effectively control power level or heating duration. Therefore, a portable heating controller offering convenience and efficiency is needed to solve this problem.

### SUMMARY

It is an objective of the present invention to provide a heating device.

It is another objective of the present invention to provide a heating device that can control heating power level or heating duration.

It is another objective of the present invention to provide a portable heating controller with a portable power source.

It is another objective of the present invention to provide a heating device that can display the remaining capacity of the portable power source.

In accordance with the foregoing objectives, an embodiment of this invention provides a portable heating device with a portable power source, which has a portable power source, a capacity detection circuit, a discharging controller, and a processor. The portable power source is used to supply the power to the portable heating device, and the capacity detection circuit is coupled to the portable power source to detect the remaining capacity of the portable power source. The discharging controller is connected between the portable power source and the heating apparatus to connect or disconnect the discharging path therebetween. The processor is coupled to the capacity detection circuit to receive the detecting result and is coupled to the discharging controller to control a conductive frequency to adjust a heating power level of the portable heating device.

### BRIEF DESCRIPTION OF THE DRAWINGS

The invention can be more fully understood by reading the following detailed description of the preferred embodiment with reference made to the accompanying drawings as follows:

FIG. 1 is a functional block diagram of a portable heating device with a portable power source according to one preferred embodiment.

FIG. 2 is a functional block diagram of the portable heating device with a portable power source according to another preferred embodiment.

FIG. 3 is a schematic diagram of one preferred embodiment of this invention applied to a coat.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention can resolve the shortcomings of the available heating devices on the market, such as the heating devices not being able to work outdoors without a power source and not being able to control heating power level. Therefore, the present invention has a portable power source to be used outdoors conveniently. Furthermore, the present invention uses a simple processor to control the heating power level by a single keystroke. The present invention can also express the heating power level of the portable heating controller and the remaining capacity of the portable power source by light emitting diodes (LED) or a liquid crystal display (LCD). The present invention can be used together with a heating apparatus put in a coat or gloves to provide warmth and comfort.

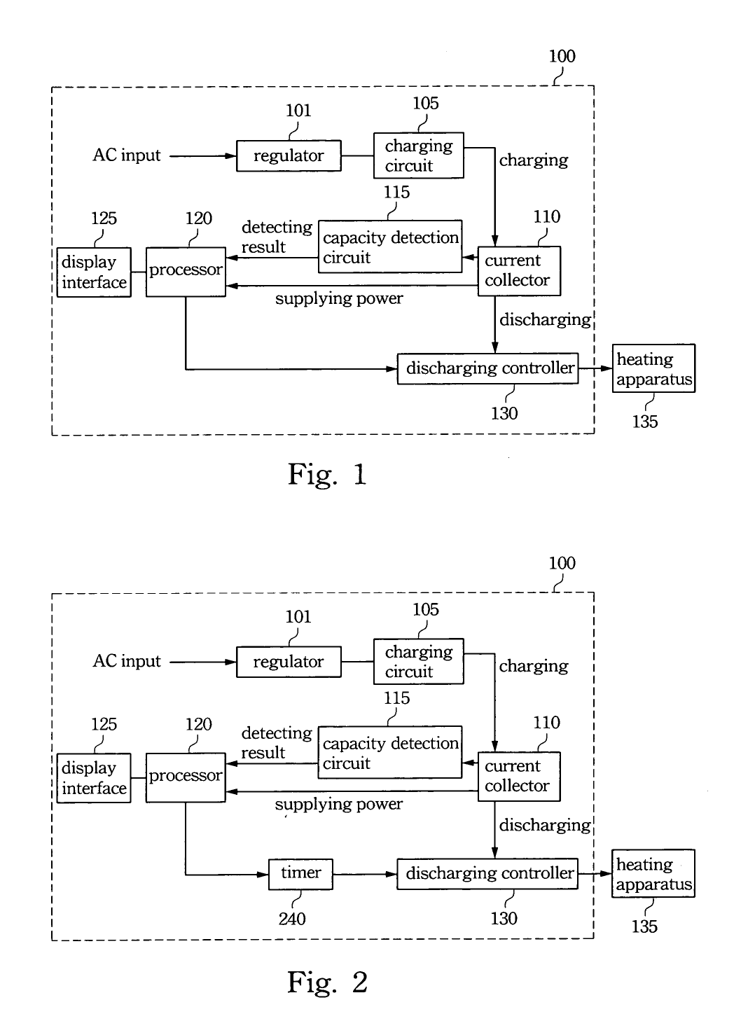

FIG. 1 is a functional block diagram of the portable heating device with a portable power source according to one preferred embodiment. According to this embodiment, this portable heating device with portable power source 100 has a regulator 101, a charging circuit 105, a portable power source 110, a capacity detection circuit 115, a discharging controller 130, a processor 120, and a display interface 125.

The function of each block in FIG. 1 is described as follows. The regulator 101 is used to transform and rectify an input current to be a charging source for the portable heating device with portable power source 100. The regulator 101 couples to the portable power source 110 by the charging circuit 105 for charging the portable power source 110, and the quantity or capacity of the portable power source 110 is adjustable according to the user (not shown). The portable power source 110 also couples to the capacity detection circuit 115 and the discharging controller 130. The capacity detection circuit 115 is used to detect an remaining capacity of the portable power source 110, and the discharging controller 130 is used to connect or disconnect the discharging path of the portable power source 110. The discharging controller 130 can be implemented by ordinary pulse width modulator (PWM) circuits. Furthermore, the discharging controller 130 couples to a heating apparatus 135 heated by the discharging of the portable power source 110, and the quantity or capacity of the heating apparatus 135 is adjustable according to the user (not shown). The processor 120 coupled to the capacity detection circuit 115 is used to receive the detecting result from the capacity detection circuit 115 and expresses the result on the display interface 125. The processor 120 can control a conductive frequency of the discharging controller 130 to adjust power level of the portable power source 110. The portable power source 110 can be a battery pack, a fuel cell or a solar cell such kind of portable power source and the heating apparatus 135 can be an electric heating pad.

The processor 120 in FIG. 1 can be implemented by a basic microprocessor. The conductive frequency of the discharging controller 130 can adjust the power level of the portable power source 110, wherein when the conductive frequency increases, the temperature of the heating apparatus increases; and when the conductive frequency is zero, the portable heating controller does not heat the heating apparatus. Furthermore, certain sequential pressing of a single key can be used to control the conductive frequency, and the duration of the keystroke can be used to turn the portable heating controller on or off.

The display interface 125 can be implemented by two groups of LEDs, wherein one group expresses the remaining capacity of the portable power source 110, and the other group expresses the power level of the portable power source 110. For example, the LEDs of the group expressing the remaining capacity of the portable power source 110 generate a first colored light (such as green light) when the remaining capacity of the portable power source is about full, generate a second colored light (such as orange light) when the remaining capacity of the portable power source is about half, generate a third colored light (such as red light) when the remaining capacity of the portable power source is about empty, and generate a flashing colored light (such as red flashing light) when the remaining capacity of the portable power source is fully empty. The LEDs of the group expressing the power level of the portable power source 110 generate a fourth colored light (such as red light) when the power level is high, generate a fifth colored light (such as orange light) when the power level is medium, and generate a sixth colored light (such as green light) when the power level is low. By the expression on the display interface 125, the portable heating controller with portable power source 100 can show the remaining capacity and the power level of the portable power source 110 easily and clearly.

The display interface 125 can also be implemented by an LCD to express the remaining capacity and the power level of the portable power source 110. Otherwise, the capacity detection circuit 115, the discharging controller 130 and the processor 120 can be integrated as a module (not shown).

FIG. 2 is a functional block diagram of the portable heating controller with a portable power source according to another preferred embodiment. The difference between FIG. 1 and FIG. 2 is that the embodiment of FIG. 2 has an extra timer 240 coupling to the processor 120 and the discharging controller 130. The timer 240 is used to control the heating duration of the heating apparatus 135.

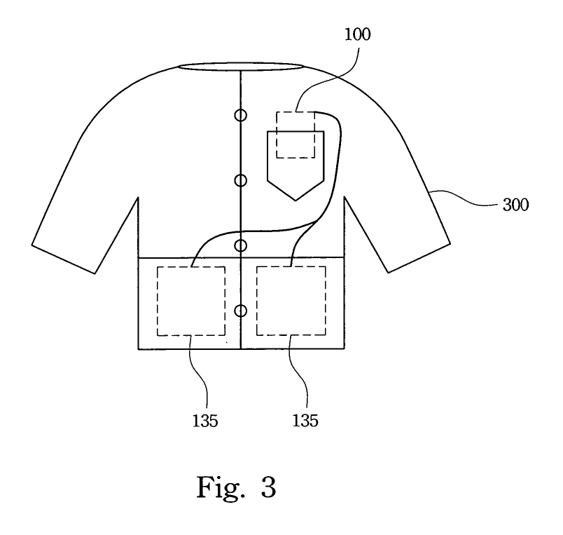

FIG. 3 is a schematic diagram of one preferred embodiment of this invention applied to a coat. There are two heating apparatuses 135 in the pockets of coat 300, and the portable heating controller with portable power source 100 can display the remaining capacity and the power level. The portable heating controller with portable power source 100 with these heating apparatuses 135 can also be applied to gloves or earflaps to stay warm and comfortable.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable heating controller with portable power source used to heat at least one heating apparatus, comprising:
a portable power source arranged to supply power to the portable heating controller;
a capacity detection circuit coupling to the portable power source arranged to detect an remaining capacity of the portable power source;
a discharging controller connecting between the portable power source and the heating apparatus arranged to connect or disconnect the discharging path between the portable heating controller and the heating apparatus; and,
a processor coupling to the capacity detection circuit, arranged to receive the detecting result, and coupling to the discharging controller, arranged to control a conductive frequency to adjust power level of the portable heating controller.

2. The portable heating controller with portable power source of claim 1, wherein the processor is arranged to control the conductive frequency by a single keystroke.

3. The portable heating controller with portable power source of claim 1, wherein when the conductive frequency increases, the temperature of the heating apparatus increases and when the conductive frequency is zero, the portable heating controller does not heat the heating apparatus.

4. The portable heating controller with portable power source of claim 1, further comprising a timer coupling to the processor and the discharging controller, arranged to control the heating duration of the heating apparatus.

5. The portable heating controller with portable power source of claim 1, further comprising a display interface coupling to the processor, arranged to express the remaining capacity and the power level of the portable power source.

6. The portable heating controller with portable power source of claim 5, wherein the display interface comprises an LCD interface, arranged to express the remaining capacity and the power level of the portable power source.

7. The portable heating controller with portable power source of claim 5, wherein the display interface comprises a plurality of LEDs, arranged to express the remaining capacity of the portable power source.

8. The portable heating controller with portable power source of claim 5, wherein the display interface comprises a plurality of LEDs, arranged to express the power level of the portable power source.

9. The portable heating controller with portable power source of claim 7, wherein the plurality of LEDs generates a first colored light when the remaining capacity of the portable power source is about full, generates a second colored light when the remaining capacity of the portable power source is about half full, generates a third colored light when the remaining capacity of the portable power source is about empty, and generates a flashing light when the remaining capacity of the portable power source is substantially empty.

10. The portable heating controller with portable power source of claim 8, wherein the plurality of LEDs generates a fourth colored light when the power level is high, generates a fifth colored light when the power level is medium, and generates a sixth colored light when the power level is low.

11. The portable heating controller with portable power source of claim 1, further comprising a charging circuit coupling to the portable power source, arranged to charge the portable power source.

12. The portable heating controller with portable power source of claim 11, further comprising a regulator coupling to the charging circuit, arranged to transform and rectify an input current.

13. The portable heating controller with portable power source of claim 1, wherein the portable power source is a battery pack.

14. The portable heating controller with portable power source of claim 1, wherein the heating apparatus is an electric heating pad.

15. A portable heating controller with portable power source used to heat at least one heating apparatus, comprising:
a portable power source arranged to supply power to the portable heating controller; and,
a control module coupling to the portable power source, arranged to detect an remaining capacity of the portable power source and control a power level of the portable heating controller.
